(19) United States
(12) Patent Application Publication
(10) Pub. No.: US 2013/0191064 A1
(43) Pub. Date: Jul. 25, 2013

(54) APPARATUS AND METHOD FOR CONTROLLING WATER QUALITY SENSOR FAULTS USING SENSOR DATA

(71) Applicant: Electronics and Telecommunications Research Institute, Daejeon (KR)

(72) Inventors: Hyeon Park, Daejeon (KR); Chang Won Lee, Kyeonggi-do (KR); Gwan Joong Kim, Daejeon (KR)

(73) Assignee: Electronics and Telecommunications Research Institute, Daejeon (KR)

(21) Appl. No.: 13/749,077

(22) Filed: Jan. 24, 2013

(30) Foreign Application Priority Data
Jan. 25, 2012 (KR) 10-2012-0007392

(51) Int. Cl. G06F 11/00

(52) U.S. Cl. CPC G06F 11/00
USPC 702/104

(57) ABSTRACT

Disclosed in an apparatus and method for restoring sensor data faults remotely that are caused due to an impurity attached to a water quality sensor, by using sensor data, the apparatus including, a fault determining unit to determine whether the water quality sensor is faulty using fault related data when the sensor data received from a sensor node is an outlier value, and a cleaning device requesting unit to request operation of a cleaning device that removes an impurity of the water quality sensor when the water quality sensor is determined to be normal.

### CROSS-REFERENCE TO RELATED APPLICATION

This application claims the priority benefit of Korean Patent Application No. 10-2012-0007392, filed on Jan. 25, 2012, in the Korean Intellectual Property Office, the disclosure of which is incorporated herein by reference.

### BACKGROUND

1. Field of the Invention

The present invention relates to an apparatus and method for controlling water quality sensor faults, and more particularly, to an apparatus and method for controlling water quality sensor faults that restores sensor data faults that are caused by an impurity attached to the water quality sensor, by using the sensor data.

2. Description of the Related Art

Recently, a water quality evaluation is being conducted via a sensor by directly installing a ubiquitous sensor network (USN) based sensor, focusing on small streams.

However, since a conventional USN based water quality evaluation system is conducted in a passive manner that only notifies a user of management information with respect to a network equipment, when a fault occurs in network elements, the fault may not be detected accurately, and follow-up measures may not be automatically taken based on the fault.

Also, when a fault occurs due to an impurity attached to a water quality sensor, therein lies a limit in that the fault is not detected and measures corresponding to the fault are not carried out in real time.

Accordingly, there is a desire for a method of determining a location of a fault when the fault occurs in the water quality sensor, and of restoring a fault automatically when the fault occurs due to an impurity attached to the sensor.

### SUMMARY

An aspect of the present invention provides an apparatus and method for determining whether a water quality sensor is faulty using fault related data, when a water quality evaluating unit determines sensor data to be an outlier value.

Another aspect of the present invention also provides an apparatus and method for restoring a fault remotely by cleaning the water quality sensor remotely, when a water quality sensor that transmits sensor data that is an outlier value is not faulty.

Still another aspect of the present invention also provides an apparatus and method for restoring water quality sensor faults rapidly by determining a number of times a cleaning device is operated using cleaning history of a water quality sensor, and thereby omitting a process of determining whether the sensor data is the outlier value.

According to an aspect of the present invention, there is provided an apparatus for controlling water quality sensor faults, the apparatus including a fault determining unit to determine whether a water quality sensor is faulty using fault related data when sensor data received from a sensor node is an outlier value, and a cleaning device requesting unit to request operation of a cleaning device that removes an impurity from the water quality sensor when the water quality sensor is determined to be normal.

The apparatus for controlling the water quality sensor faults may further include a water quality determining unit to determine a water quality of a location in which a sensor node is installed using sensor data, and to determine an existence of an outlier value in the sensor data.

The cleaning device requesting unit may request continuous operation of the cleaning device based on the determined number of requests for the operation of the cleaning device.

Another aspect of the present invention provides a sensor node, including a water quality sensor to measure data related to a water quality, a cleaning device controlling unit to control a cleaning device and remove an impurity attached to the water quality sensor, and a sensor data transmitting unit to generate sensor data based on the measured data and transmit the sensor data to an apparatus for controlling water quality sensor faults.

Still another aspect of the present invention provides a system for evaluating a water quality, the system including a sensor node to measure data related to a water quality obtained by a water quality sensor and remove an impurity attached to the water quality sensor, and an apparatus for controlling water quality sensor faults to determine whether the water quality sensor is faulty using fault related data when sensor data received from the sensor node is an outlier value, and request operation of a cleaning device that removes the impurity of the water quality sensor based on a result of the determination.

Yet another aspect of the present invention provides a method for controlling water quality sensor faults, the method including determining whether the water quality sensor is faulty using fault related data when sensor data received from a sensor node is an outlier value, and requesting operation of a cleaning device that removes an impurity from the water quality sensor when the water quality sensor is determined to be normal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system for evaluating a water quality according to an embodiment of the present invention;

FIG. 2 is a block diagram illustrating an apparatus for controlling water quality sensor faults according to an embodiment of the present invention;

FIG. 3 is a block diagram illustrating a water quality sensor node according to an embodiment of the present invention;

FIG. 4 is an example describing a process of determining a number of requests for operation of a cleaning device according to an embodiment of the present invention;

FIG. 5 is a flowchart illustrating a method for controlling water quality sensor faults according to an embodiment of the present invention; and

FIG. 6 is a flowchart illustrating a method for operating a cleaning device according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

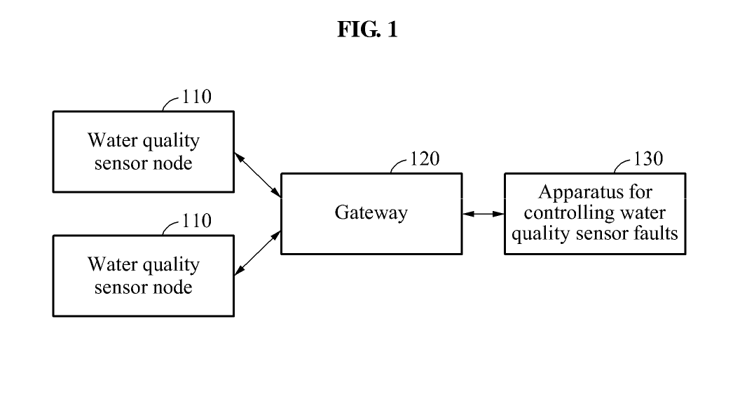

FIG. 1 is a diagram illustrating a system for evaluating a water quality according to an embodiment of the present invention.

The system for evaluating the water quality, hereinafter referred to as a “water quality evaluation system”, may include a plurality of water quality sensor nodes 110, a gateway 120, and an apparatus for controlling water quality sensor faults 130.

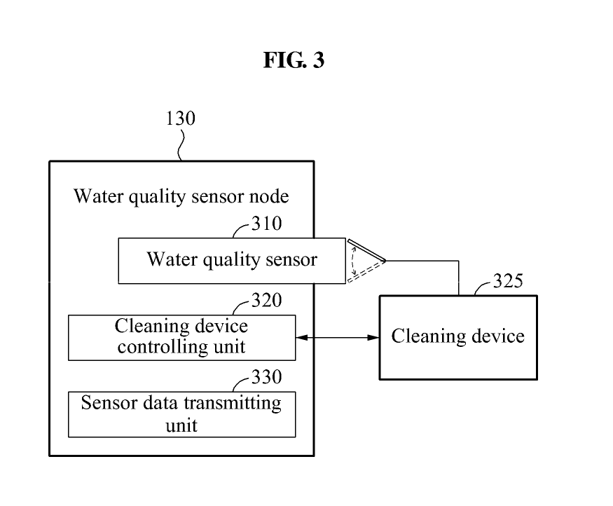

The plurality of water quality sensor nodes 110 installed at a location where a water quality is intended to be measured may measure a water quality via a water quality sensor, and transmit sensor data to the apparatus for controlling the water quality sensor faults 130 through the gateway 120. Hereinafter, a detailed configuration of the plurality of water quality sensor nodes 110 will be described with reference to FIG. 3.

Here, the plurality of water sensor nodes 110 may include a cleaning device and clean the water quality sensor according to a remote control of the apparatus for controlling the water quality sensor faults 130.

The gateway 120 may collect sensor data transmitted from the plurality of water quality sensor nodes 110, and transmit the collected sensor data to the apparatus for controlling the water quality sensor faults 130. More particularly, the gateway 120 may transmit a sensor data requesting signal to the plurality of water quality sensor nodes 110 regularly, collect the sensor data transmitted from the plurality of water quality sensor nodes 110, and transmit the collected sensor data to the apparatus for the water quality sensor faults 130.

Also, the gateway 120 may include a gateway controlling unit, a radio frequency (RF) module controlling unit, a ubiquitous sensor network (USN) communication unit that receives sensor data from the plurality of water quality sensor nodes 110, and a gateway network management unit that controls management data in conjunction with the USN communication unit.

The apparatus for controlling the water quality sensor faults 130 may evaluate a water quality of a location at which the plurality of water sensor nodes 110 are installed, by the sensor data collected from the plurality of water sensor nodes 110 through the gateway 120.

Here, the apparatus for controlling the water quality sensor faults 130 may determine whether the water quality sensor included in the plurality of water quality sensor nodes 110 is faulty, using the collected sensor data. Also, when a fault occurs in the sensor data in a situation in which the water quality sensor included in the plurality of water quality sensor nodes 110 is not faulty, the apparatus for controlling the water quality sensor faults 130 may remotely control the cleaning device of a corresponding water quality sensor node 110 to clean the water quality sensor of the corresponding water quality sensor node 110, and restore the fault caused due to an impurity attached to the water quality sensor.

That is, the water quality evaluation system may determine whether the water quality sensor is faulty when a water quality evaluating unit of the apparatus for controlling the water quality sensor faults determines the sensor data to be the outlier value, and when the water quality sensor is not faulty, the water quality evaluation system may determine that an impurity is attached to the water quality sensor, clean the water quality sensor remotely, and thus resolve the fault of the water quality sensor.

In addition, an appropriate number of times the water quality sensor is cleaned may be determined by determining a number of times the cleaning device is operated, using cleaning history information of a water quality sensor, without determining whether the sensor data is the outlier value.

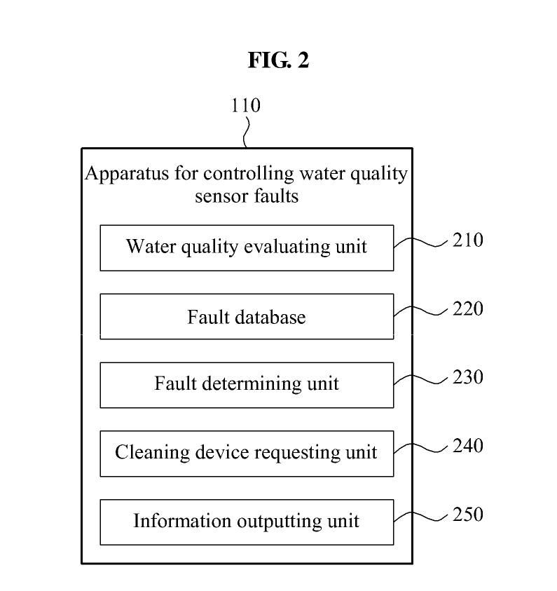

FIG. 2 is a block diagram illustrating an apparatus for controlling water quality sensor faults according to an embodiment of the present invention.

Referring to FIG. 2, the apparatus for controlling the water quality sensor faults 130 may include a water quality evaluating unit 210, a fault database 220, a fault determining unit 230, a cleaning device requesting unit 240, and an information outputting unit 250. Here, the fault determining unit 230 and the cleaning device requesting unit 240 may be included in a server network management module of the apparatus for controlling water quality sensor faults 130.

The water quality evaluating unit 210 may evaluate a water quality of a location at which a water quality sensor node 110 is installed, using sensor data received from the water quality sensor node 110 through a gateway 120.

Here, the water quality evaluating unit 210 may determine an existence of an outlier value in the received sensor data.

Also, since a corresponding sensor data is data for determining whether the outlier value is removed in the sensor data by the cleaning device, the water quality evaluating unit 210 may omit a water quality evaluation using the sensor data, and only determine the presence of the outlier value in the received sensor data when the water quality evaluating unit 210 receives the sensor data from the water sensor node 110.

The fault database 220 may save and manage fault related data for identifying water quality sensor faults included in the water sensor node 110. Here, the fault related data may include a water quality sensor node in which a fault occurs and a type of fault that occurs in the water quality sensor node. For example, when a fault occurs in a water quality sensor interface of a first water quality sensor node, the first water quality sensor node may be added to fault related data of the water quality sensor interface.

Here, the fault related data may include at least one of the fault related data from the water quality sensor interface, fault related data from a water quality sensor main body, and fault related data from a water quality sensor probe. Also, various fault related data may be added to the fault related data, based on a configuration of the water quality sensor node 110.

When the water quality evaluating unit 210 determines the sensor data to be an outlier value, the fault determining unit 230 may determine whether the water quality sensor included in the water quality sensor node 110 is faulty, using the fault related data saved in the fault database 220. Here, the fault determining unit 230 may verify an existence of fault related data corresponding to the water quality sensor node 110 among the fault related data from the water quality sensor interface, fault related data from the water quality sensor main body, and fault related data from the water quality sensor probe, and determine whether the water quality sensor is faulty. For example, when identification information of the water quality sensor node 110 transmitting the sensor data that is an outlier value is a first water quality sensor node, and the first water quality sensor node is included in the fault related data from the water quality sensor main body, the fault determining unit 230 may determine the water quality sensor main body of the first water quality sensor node to be faulty.

Here, the fault determining unit 230 may determine that an impurity is attached to the water quality sensor of the sensor node, and operate the cleaning device requesting unit 240 when an absence of data among the fault related data corresponding to the water quality sensor node 110 that transmits the sensor data in which the outlier value is present, is detected. Here, the fault determining unit 230 may set a waiting time based on a time period during which the cleaning device operates and a time period during which the water quality sensor is cleaned by the cleaning device, and allow the water quality determining unit 210 to determine whether the outlier value is present in the sensor data that is received subsequent to a lapse of the waiting time.

Also, the fault determining unit 230 may determine the water quality sensor node to be normal when the outlier value is absent in the sensor data that is received from the water quality sensor node.

When the fault determining unit 230 determines the water quality sensor node 110 transmitting the sensor data in which the outlier value is present to be normal, the cleaning device requesting unit 240 may send a request to the water quality sensor node 110 for operation of the cleaning device to remove the impurity of the water quality sensor.

Here, the cleaning device requesting unit 240 may save a number of times the cleaning device is operated, and determine a number of requests for operation of the cleaning device that is a number of times operation of the cleaning device is requested to the water quality sensor node 110, based on the saved number of times the cleaning device is operated.

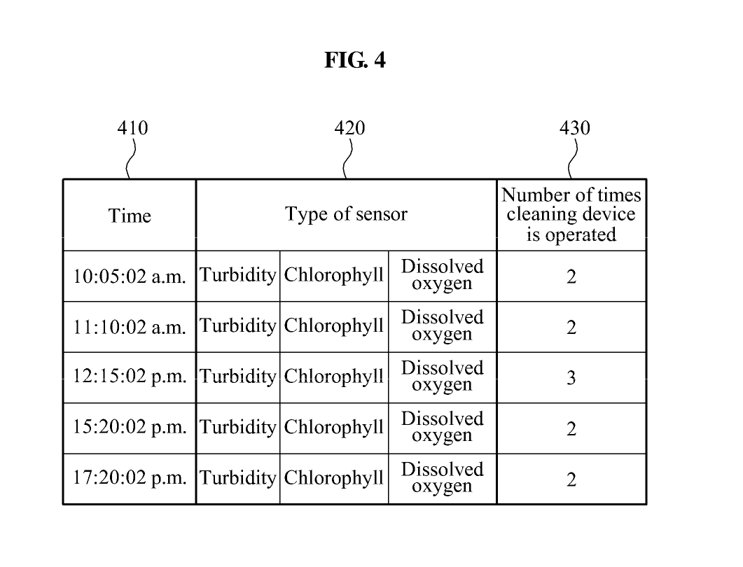

More particularly, the cleaning device requesting unit 240 may determine the number of requests for the operation of the cleaning device, based on an average of the saved number of times the cleaning device is operated. A method of determining the number of requests for the operation of the cleaning device will be described with reference to FIG. 4. Here, the cleaning device requesting unit 240 may request the water quality sensor node 110 for a continuous operation of the cleaning device, based on the determined number of requests for the operation of the cleaning device. For example, in a case of the number of requests for operation of the cleaning device being three, the cleaning device requesting unit 240 may send a request to the water quality sensor node 110 for the operation of the cleaning device three times, irrespective of a reception of the sensor data. Here, the cleaning device requesting unit 240 may request the operation of the cleaning device based on the time period during which the water quality sensor is cleaned by the cleaning device. For example, when the cleaning device sensor takes five seconds to clean the water quality, the cleaning device requesting unit 240 may postpone a reception of the sensor data from the water quality sensor node by requesting the operation of the cleaning device three times at five second intervals, and reduce a time period until the water quality sensor node 110 is returned to a normal state by omitting a time period during which an existence of the outlier value of the sensor data is determined.

For example, when the number of requests for the operation of the cleaning device is three, the cleaning device requesting unit 240 may request the water quality sensor node 110 for operation of the cleaning device up to a total of three times. When the sensor data is the outlier value subsequent to three times of operation of the cleaning device, the cleaning device requesting unit 240 may not request the water quality sensor node 110 for the operation of the cleaning device by determining that the outlier value is not removable by cleaning the water quality sensor.

When the fault determining unit 230 determines the water quality sensor node 110 to be faulty, the information outputting unit 250 may provide a type of fault that is determined by the fault determining unit 230. Here, the information outputting unit 250 may display the type of fault on a screen, and transmit a message including the type of fault to a user terminal or an e-mail.

FIG. 3 is a block diagram illustrating a water quality sensor node according to an embodiment of the present invention.

Referring to FIG. 3, the water quality sensor node 110 may include a water quality sensor 310, a cleaning device controlling unit 320, and a sensor data transmitting unit 330.

The water quality sensor 310 may measure data related to a water quality.

Here, the water quality sensor 310 may include probes for measuring a turbidity, a chlorophyll level, and a dissolved oxygen level, a water quality sensor main body, a water quality sensor interface board, and a water quality sensor battery. Here, the water quality sensor 310 may further include probes for measuring data aside from the turbidity, the chlorophyll, and the dissolved oxygen.

Also, the water quality sensor 310 may include a turbidity measuring sensor, a chlorophyll level measuring sensor, and a dissolved oxygen level measuring sensor.

That is, a water quality sensor node 110 may measure a plurality of data related to the water quality, using a sensor in which a plurality of probes are formed in a single sensor, or using a plurality of sensors.

The cleaning device controlling unit 320 may control a cleaning device 325 that is combined in the water quality sensor node 110, and remove an impurity that is attached to the water quality sensor 310.

Here, the cleaning device 325 may be installed for each of the plurality of probes of the water quality sensor 310. That is, when an outlier value is found to be present only in turbidity related sensor data among sensor data, the cleaning device controlling unit 320 may operate the cleaning device 325 corresponding to a turbidity measuring probe to clean only the turbidity measuring probe.

Also, when a probe corresponding to the outlier value is unidentifiable, the cleaning device controlling unit 320 may clean all of the probes of the water quality sensor 310 using the cleaning device 325.

The sensor data transmitting unit 330 may generate the sensor data based on data measured by the water quality sensor 310, and transmit the generated sensor data to an apparatus for controlling water quality sensor faults. Here, the sensor data transmitting unit 330 may include a USN communication module and a node network management module that controls management data in conjunction with the USN communication module.

FIG. 4 is an example describing a process of determining a number of requests for operation of a cleaning device according to an embodiment of the present invention.

When a cleaning device requesting unit 240 operated by a fault determining unit 230 requests operation of the cleaning device, a time 410 at which the operation of the cleaning device is requested as shown in FIG. 4, a type 420 of the water quality sensor cleaned by the cleaning device, and a number of times 430 the cleaning device is operated as requested may be saved.

Here, the number of times 430 the cleaning device is operated may indicate a number of times the cleaning device is operated until sensor data of the water quality sensor node 110 is returned to be a normal state. That is, according to FIG. 3, when the cleaning device is operated twice or three times, the water quality sensor node 110 may determine sensor data to be normal. Accordingly, the cleaning device requesting unit 240 may determine an average value of the number of times the cleaning device is operated, for example, “2” as illustrated in FIG. 4, to be a number of requests for operation of the cleaning device.

Also, a fault that is recoverable by cleaning the water quality sensor as shown in FIG. 3 frequently occurs in the water quality sensor node 110. Accordingly, when the water quality determining unit 210 determines the sensor data to be an outlier value, the fault determining unit 230 may determine that an impurity is attached to the water quality sensor node 110 of the water quality sensor, and operate the cleaning device requesting unit 240. Here, the cleaning device requesting unit 240 may postpone a reception of the sensor data from the water quality sensor node 110 by making two requests for the operation of the cleaning device at a regular interval based on the determined number of requests for the operation of the cleaning device, and reduce a time period until the water quality sensor node 110 becomes normal by omitting a time period during which an existence of the outlier value in the received sensor data is determined.

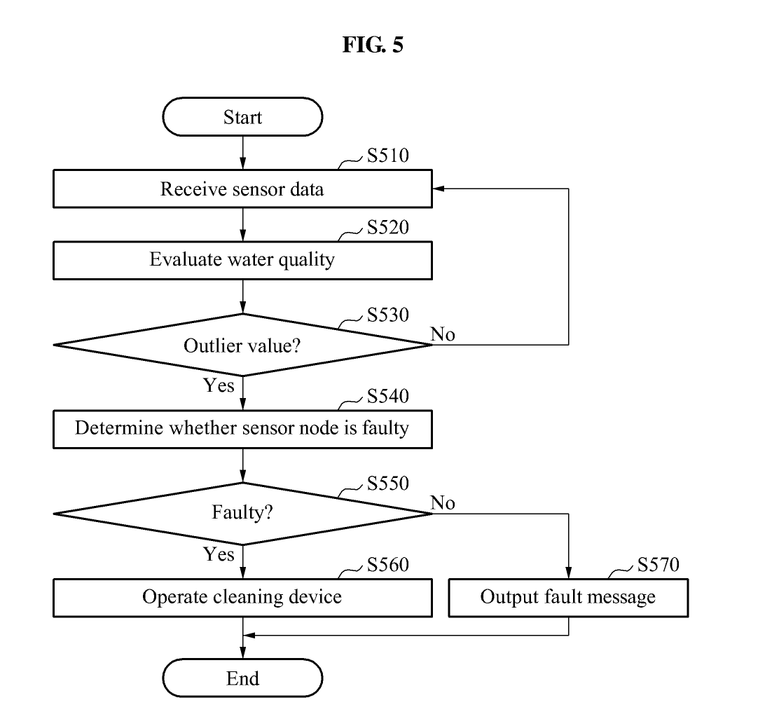

FIG. 5 is a flowchart illustrating a method for controlling water quality sensor faults according to an embodiment of the present invention.

In operation S510, a water quality evaluating unit 210 may receive sensor data from a water quality sensor node 110 through a gateway 120.

In operation S520, the water quality evaluating unit 210 may evaluate a water quality of a location at which the water quality sensor node 110 is installed, using the sensor data received in operation S510.

In operation S530, the water quality evaluating unit 210 may determine an existence of an outlier value in the sensor data received in operation S510. Here, the water quality evaluating unit 210 may perform operation S510 when the sensor data received in operation S510 is not the outlier value.

In operation S540, a fault determining unit 230 may determine whether a water quality sensor is faulty, using fault related data saved in a fault database 220 when the sensor data is determined to the outlier value in operation S530. Here, the fault determining unit 230 may verify an existence of fault related data corresponding to the water quality sensor node 110 among fault related data from a water quality sensor interface, fault related data from a water quality sensor main body, and fault related data from a water quality sensor probe, and determine whether the water quality sensor is faulty.

When an occurrence of a fault is determined to be absent in the water quality sensor in operation S540, the fault determining unit 230 may determine that an impurity is attached to the water quality sensor of the sensor node in operation S550, and thereby perform operation S560. Also, when a fault occurring location is determined in operation S540, the fault determining unit 230 may perform operation S570.

In operation S560, the cleaning device requesting unit 240 may send a request to the water quality sensor node 110 for operation of a cleaning device that removes the impurity of the water quality sensor.

In operation S570, an information outputting unit 250 may provide a type of fault that is determined in operation S540. Here, the information outputting unit 250 may display the type of fault on a screen, or transmit a message including the type of fault to a user terminal or an e-mail.

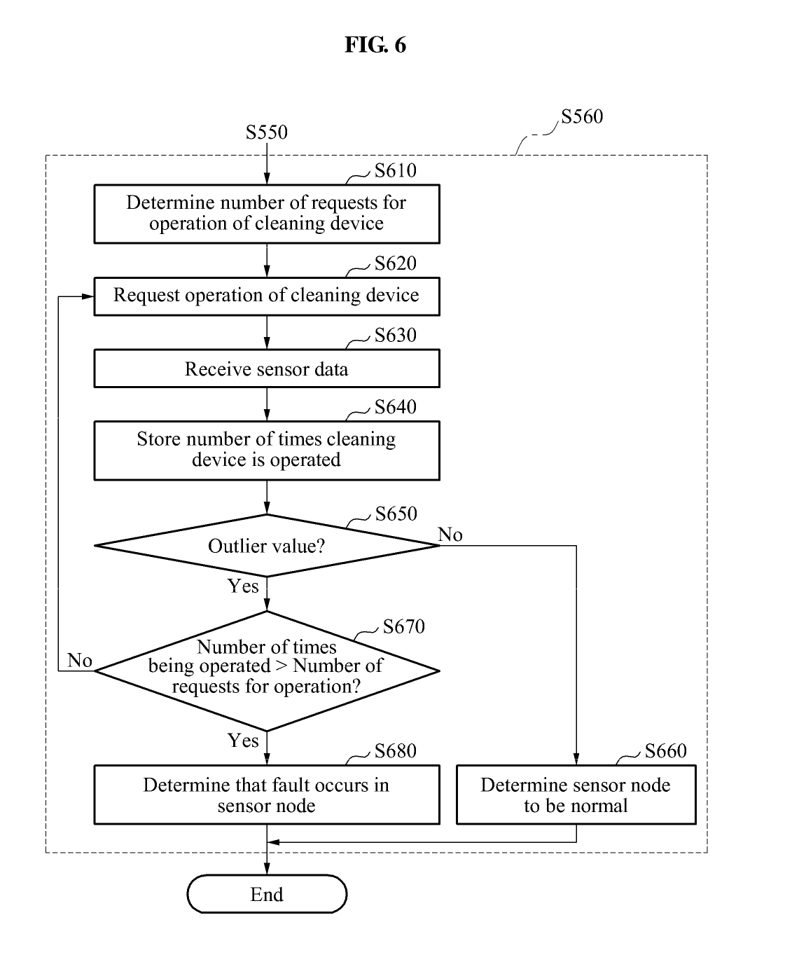

FIG. 6 is a flowchart illustrating a method for operating a cleaning device according to an embodiment of the present invention. Here, operations S610 through S680 may be included in operation S560 as shown in FIG. 5.

A cleaning device requesting unit 240 may determine a number of requests for operation of a cleaning device based on a saved number of times the cleaning device is operated. Here, the cleaning device requesting unit 240 may determine the number of requests for the operation of the cleaning device based on an average of the saved number of times the cleaning device is operated.

In operation S620, the cleaning device requesting unit 240 may request a water quality sensor node 110 for the operation of the cleaning device that removes an impurity of the water quality sensor.

In operation S630, a water quality evaluating unit 210 may receive sensor data from the water quality sensor node 110 based on the request for the operation of the cleaning device in operation S620.

In operation S640, the cleaning device requesting unit 240 may save a number of times the cleaning device is operated in the water quality sensor node 110. Here, the number of times the cleaning device is operated may indicate a number of performances of operation S620.

In operation S650, the water quality evaluating unit 210 may determine an existence of an outlier value in the sensor data received in operation S630. Here, when the outlier value is determined to be absent in the sensor data, the fault determining unit 230 may determine that the water quality sensor node is returned to a normal state by the cleaning device, and thereby perform operation S660.

In operation S660, an information outputting unit 250 may provide a user with information that the water quality sensor node 110 is returned to a normal state by the cleaning device.

In operation S670, the cleaning device requesting unit 240 may determine whether the number of times the cleaning device is operated saved in operation S640 is greater than the number of requests for the operation of the cleaning device determined in operation S610.

Here, when the number of times the cleaning device is operated saved in operation S640 is less than the number of requests for the operation of the cleaning device determined in operation S610, the cleaning device requesting unit 240 may determine that the outlier value is removable by cleaning the water quality sensor, and thereby repeat operation S620. In operation S680, when the number of times the cleaning device is operated is determined to be greater than the number of requests for the operation of the cleaning device in operation S670, the fault determining unit 230 may determine that a new fault that does not correspond to fault related data and the outlier value is not removable by cleaning is occurring in the water quality sensor, and thus notifies the user of an occurrence of the fault via the information outputting unit 250.

When the water quality evaluating unit 210 determines the sensor data to be the outlier value, the present invention may determine whether the water quality sensor is faulty, and when the water quality sensor is not faulty, the impurity is determined to be attached to the water quality sensor, and restore water quality sensor faults remotely by cleaning the water quality sensor remotely.

Also, an appropriate number of times the water quality sensor is cleaned may be determined by determining the number of times the cleaning device is operated, using cleaning history information of a water quality sensor, without determining the existence of the outlier value in the sensor data.

According to an embodiment of the present invention, when a water quality evaluating unit determines sensor data to be an outlier value, it is possible to determine whether a water quality sensor is faulty using fault related data.

According to an embodiment of the present invention, when a water quality sensor that transmits sensor data that is an outlier value is not faulty, a fault caused due to an impurity attached to the water quality sensor may be restored remotely, by cleaning the water quality sensor remotely.

According to an embodiment of the present invention, an appropriate number of times a water quality sensor is cleaned may be determined by determining a number of times a cleaning device is operated, using cleaning history information of a water quality sensor, without a process of determining whether sensor data is an outlier value.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for controlling water quality sensor faults, the apparatus comprising:
a fault determining unit to determine whether a water quality sensor is faulty using fault related data when sensor data received from a sensor node is an outlier value; and
a cleaning device requesting unit to request operation of a cleaning device that removes an impurity from the water quality sensor when the water quality sensor is determined to be normal.

2. The apparatus of claim 1, wherein the fault determining unit verifies an existence of the fault related data corresponding to the sensor node among fault related data from an interface of the water quality sensor, fault related data from a main body of the water quality sensor, and fault related data from a probe of the water quality sensor, and determines whether the water quality sensor is faulty.

3. The apparatus of claim 1, further comprising:
a water quality determining unit to determine a water quality of a location in which a sensor node is installed using sensor data, and to determine an existence of an outlier value in the sensor data.

4. The apparatus of claim 1, wherein the fault determining unit determines the water quality sensor to be normal when an outlier value is absent in the sensor data received from the sensor node, and
the cleaning device requesting unit saves a number of times the cleaning device is operated in the sensor node.

5. The apparatus of claim 4, wherein the cleaning device requesting unit determines a number of requests for the operation of the cleaning device based on the saved number of times the cleaning device is operated.

6. The apparatus of claim 5, wherein the cleaning device requesting unit requests continuous operation of the cleaning device based on the determined number of requests for the operation of the cleaning device.

7. A sensor node, comprising:
a water quality sensor to measure data related to a water quality;
a cleaning device controlling unit to control a cleaning device and remove an impurity attached to the water quality sensor; and
a sensor data transmitting unit to generate sensor data based on the measured data and transmit the sensor data to an apparatus for controlling water quality sensor faults.

8. A system for evaluating a water quality, the system comprising:
a sensor node to measure data related to a water quality obtained by a water quality sensor and remove an impurity attached to the water quality sensor; and
an apparatus for controlling water quality sensor faults to determine whether the water quality sensor is faulty using fault related data when sensor data received from the sensor node is an outlier value, and request operation of a cleaning device that removes the impurity of the water quality sensor based on a result of the determination.

9. A method for controlling water quality sensor faults, the method comprising:
determining whether the water quality sensor is faulty using fault related data when sensor data received from a sensor node is an outlier value; and
requesting operation of a cleaning device that removes an impurity from the water quality sensor when the water quality sensor is determined to be normal.

10. The method of claim 9, wherein the determining whether the water quality sensor is faulty comprises:
verifying an existence of fault related data corresponding to a sensor node among fault related data from an interface of the water quality sensor, fault related data from a main body of the water quality sensor, and fault related data from a probe of the water quality sensor, and determining whether the water quality sensor is faulty.

11. The method of claim 9, further comprising:
evaluating a water quality of a location at which a sensor node is installed using sensor data; and
determining an existence of an outlier value in the sensor data.

12. The method of claim 9, wherein the determining whether the water quality sensor is faulty comprises:
determining the water quality sensor to be normal when an outlier value is absent in sensor data received from a sensor node, and
the requesting operation of the cleaning device comprises:
storing a number of times the cleaning device is operated in the sensor node.

13. The method of claim 12, further comprising:
determining a number of requests for the operation of the cleaning device based on the saved number of times the cleaning device is operated.

14. The method of claim 13, wherein the requesting operation of the cleaning device comprises:
requesting continuous operation of the cleaning device based on the determined number of requests for the operation of the cleaning device.

15. A method for operating a sensor node, the method comprising:
measuring data related to a water quality;
removing, by controlling a cleaning device, an impurity attached to a water quality sensor; and
generating sensor data based on the measured data and transmitting the sensor data to an apparatus for controlling water quality sensor faults.
